(19) United States
(12) Patent Application Publication
(10) Pub. No.: US 2007/0094324 A1
(43) Pub. Date: Apr. 26, 2007

(54) Web-based, secure supervisory system for social guidance and professional consultation and method of use

(76) Inventor: Korkut Celal Vata, Raleigh, NC (US)

Correspondence Address: Korkut Vata, Apt. 102, 1105 Pine Winds Drive, Raleigh, NC, 27603, US

(21) Appl. No.: 11/242,229

(22) Filed: Oct. 3, 2005

(51) Int. Cl. G06F 15/16

(52) U.S. Cl. 709/203

(57) ABSTRACT

The invention provides a supervisory internet system designed for organized information retrieval under professional expertise and/or social guidance. The invention has three components, a supervisor, a supervised entity and a system enabling informed web-guidance. Being an expert in a particular filed and/or a social partner of the beneficiary (supervised entity), the supervisor is in charge of the framed information retrieval directed for the use of the beneficiary (supervised entity). Professional expertise and/or social skills of the supervisory entity, which enables directed information retrieval is the distinguishing feature of the system. In addition to organizing the systemic information retrieval, the system is a dynamic embodiment and learns and updates itself through continuous communication with the supervisor. A reverse matching system, where the supervisor matches several profiles to an exemplary profile in the system is a feature which provides evaluation of multiple profiles. A portal to third parties under the informed consent of the supervisor enables information exchange with other experts and researches.

### FIELD OF THE INVENTION

This invention provides a supervisory internet system targeting the needs of the beneficiary supervised entity, wherein the user of the system is not the primary beneficiary, but a supervisor to the beneficiary.

### BACKGROUND OF THE INVENTION

There are various information retrieval methods from internet for individual purposes. Google search is the particular example of these information retrieval systems. These systems are used by individuals for various purposes world-wide. Even though access to the information via these routes are very quick and well designed, current systems can not deal with unrelated background information. Ever growing internet and everyday data deluge makes it almost impossible to access specific information for particular purposes. Most of the time retrieved information requires interpretation and framing by an expert. This invention aims to fulfill the need for expert directed, organized information retrieval on the internet for the use of the supervised entity, the beneficiary.

Prior art matching systems provide matching between a user and a second party but each case requires that the user is the one being matched with another entity, i.e., the user is the primary beneficiary of the system. Prior Art is mainly confined to dating related social interaction without aiming any other social service or professional guidance including U.S. Published Application No. 20050131716 (Hanan, et al.) and U.S. Pat. No. 6,061,681 (Collins).

Thus there remains a need for a system and method for providing a secure supervisory matching system that provides for a user who is independent and acting on behalf or in the interest of matching the needs and factors related to a beneficiary under the supervision of the user.

### SUMMARY OF THE INVENTION

The invention provides a supervisory internet system designed for organized information retrieval under social or professional expertise and/or social guidance on behalf of the beneficiary. The system has three components, a supervisor, a supervised entity and an organizer internet system. Being an expert in a particular filed and/or a social partner of the beneficiary (supervised entity), the supervisor is in charge of the directed information retrieval for the direct use of the beneficiary (supervised entity). Professional expertise and/or social position and skills of the supervisory entity enables the system to retrieve refined information for the use of supervised entity. The supervised entity is the actual beneficiary of the system, while, the supervisor has a serving position due to his/her professional expertise and/or social relation to the supervised entity (primary beneficiary). The supervised entity requires supervision because he/she lacks the professional expertise and/or is not capable of using the basic internet system.

A profile of the supervised entity containing a set of characteristics, related to the service will be used to frame the directed information retrieval by the supervisor. Examples included but not limited to age, sex, medical condition, gene expression profile, size, cultural preferences. The profile may also include a set of characteristic information regarding the supervisor if necessary. Examples include, but not limited to economic status, profession, education level, religious background, nationality, etc. The final profile will be framed by the supervisor according to his/her expertise and according to the categorized profile outlines provided by the system. In the case of multiple supervised entities a supervisor can use his/her electronic database to frame multiple beneficiary profiles and enable faster information processing.

The search is framed for the supervised entity either for professional consulting purposes and/or for social guidance. Examples for the first case include but are not limited to professional consultancy provided by doctors, lawyers, pharmacogenomics experts. The examples to the ladder case without limitation includes parental guidance for children, help to the elderly.

The system is a dynamic entity, where the results of search and resulting service is communicated back to the system by the supervisor. The supervisor's response is updated and processed in a neural network setting to design further information retrieval. Both positive and negative feedbacks are processed and interpreted to optimize future responses. Information is updated and shared with the supervisors continuously aiming for the better future services for the supervised entity, the beneficiary.

A portal to third parties under the informed consent of the supervisor enables the system to share information at a higher level. Accumulated information and records can be exchanged with third party experts and researches under the informed consent of the supervisor and according to the technical facilities of the system. This forms a portal where academicians, researchers, and experts can access organized information only under the informed consent of the supervisor.

These and other aspects of the present invention will become apparent to those skilled in the art after a reading of the following description of the preferred embodiment when considered with the drawings.

### DETAILED DESCRIPTION OF THE INVENTION

In the following description, like reference characters designate like or corresponding parts throughout the several views. Also in the following description, it is to be understood that such terms as “forward,” “rearward,” “front,” “back,” “right,” “left,” “upwardly,” “downwardly,” and the like are words of convenience and are not to be construed as limiting terms.

The present invention provides an on-line system for supervisory matching including at least one server hosting a secure database and connected to a network over which at least one remote, authorized user can access the server through the network using at least one remote computer or network access device operable to communicate and interface with the server. The server further includes software that provides for Internet or other secure network-based use by authorized users for providing remote access to enter information and retrieve matching results and other communication or information.

In preferred embodiments of the present invention the at least one remote authorized user is the supervisor for a third party who cannot themselves access and/or use the system. In one embodiment, the supervisor is a parent and the supervised entity is a child. In any case, the beneficiary is not capable directly using the system and is selected from the group consisting of children, pets, elderly persons, job applicants, and combinations thereof.

Importantly, the parent or supervisor is the actual user of the system for the purpose of matching the interests, factors, or needs of at least one beneficiary. The supervisor, who is the actual user of the system interfaces with the server remotely to search for matches based upon profiles—the target profile or desired qualities that are entered into the system by the user, but profiles relate substantially and most directly to the non-user beneficiary of the system.

In one embodiment, the present invention provides for a system for reverse matching between parties, the system including: at least one server hosting a secure database and connected to a network over which at least one remote, authorized user can access the server through the network using at least one remote computer or network access device operable to communicate and interface with the server, the server further including software for matching a profile entered by the user on behalf of at least one beneficiary, wherein the profile predominantly relates directly to the at least one beneficiary, not the user.

In preferred embodiments of the present invention, the user of the system is a supervisor and the at least one beneficiary is a supervised entity under the supervisor. In an exemplary embodiment, the user is a parent and the beneficiary is a child. The system and methods of using it provide for matching to be direct matching of the profiles related to the beneficiary and an unrelated party, which may be a single individual, or a group of individuals.

Preferably, the matching may be selected to be either one-way matching between one beneficiary and a single individual, or more preferably, multi-way matching. The multi-way matching includes matching between multiple parties, and provides for matching between the profile associated with one beneficiary to multiple candidate profiles, and/or matching of multiple candidate profiles to one exemplar profile. The profile provided into the system by the user includes a plurality of factors, which are preferably prioritized by the user. Where prioritization is provided, the system and methods provide for matching outputs wherein the matching is ranked by relevance to the prioritization. Priorities may be provided arbitrarily or systematically by the user, and may be based upon responses to a questionnaire. Also, the priorities are based upon a predetermined number of top priorities, such as at least five or more factors, although the number of prioritized factors is dependent upon the system settings or user options, and merely requires at least two factors in order to give an option for prioritization.

The matching outputs provided by the system and method of the present invention direct matching or reverse-matching. In the case of reverse-matching, the matching is coordinated by a group toward a single opportunity, such as, by way of example and not limitation, reverse matching by a pool of candidates for a single job opportunity. The profile further includes a plurality of factors and characteristics associated with either the beneficiary or the user; this may include several sets of factors, such as a first factor set associated primarily with parent, including but not limited to economic status, profession, education level, religious background, nationality, and combinations thereof; a second factor set associated primarily with the beneficiary, including but not limited to age, size, medical conditions, skills, talents, and combinations thereof; and/or a third factor set associated primarily with both the user and beneficiary, including but not limited to geography, culture, social preferences, language preferences, adoption background, and combinations thereof.

The profile also optionally includes factors selected from the group consisting of schedule, reason for matching, play dates for kids/pets, joint cultural activities, locating service providers such as nanny, pet-sitter, pediatrician, selling or exchanging information or items such as clothing, furniture, charity, photographs, health-related info, and combinations thereof.

The system is operable to permit the user to input, modify, delete, and/or store data input by that user, which may be authenticated by user password, code or other unique user identifier. For any users, the profiles are stored on a secure, private database, and the profile information is provided anonymously to a third party not associated with the matching of beneficiary with user consent. In such cases of third party anonymized data, the information is used for market research and/or medical social research, and/or used to provide services back to the users based on the profile, or provide a basis for the user and/or beneficiary to be included or invited for participation in studies such as medical or product studies.

The present invention also provides for a method for matching profiles in a system, including the steps of:
providing a system for direct and/or reverse matching between parties, the system comprising:
at least one server hosting a secure database and connected to a network over which at least one remote, authorized user can access the server through the network using at least one remote computer or network access device operable to communicate and interface with the server, the server further including software for matching a profile entered by the user on behalf of at least one beneficiary, wherein the profile predominantly relates directly to the at least one beneficiary, not the user;
the user logging into the system via a user interface on the Internet;
the user paying a fee for a membership to participate in the matching by the system;
the user initializing the profile;
the system comparing the profile to others in its database; and the system providing matching profiles to the user.

Also, the step of the user initializing the profile is operable based upon the user answering questions, making a free-form entry of information, uploading data such as pictures and links, and combinations thereof. The step of the system suggesting categories for considering matches based on a completed profile, which is supplied by the user on behalf of the beneficiary, who is unable to access the system independently. As set forth above in the system, the user may also have the option of prioritizing factors within the profile. Based upon the profile, prioritized or not, the system identifies a best match based upon entered profile and prioritized factors within the profile, and then notifies all users associated with matching profiles. After that the users notified by the system decide and indicate a response to the system before the system completes the matching. Thereafter, the system is operable to provide contact info to users who have indicated acceptance of the matching. Optionally, the users can choose to be contacted directly.

In preferred embodiments, an additional step of the users providing feedback to indicate satisfaction with the match is used and the system automatically learns what match types were unsatisfactory and avoids repeating those profile matches in later matches.

Additionally, in one embodiment of the present invention, at least one supervisor uses the system via login to the website of the system provider. Either a paid membership or long term subscription is purchased. A profile of the supervised entity (primary beneficiary) is build based on the categorized sample profiles provided by the system and/or based on the expert help of the supervisor. The sample profiles are in a questioner setting and supervisory help will be in essay setting. All additional information such as pictures, web-links are uploaded automatically. For supervisors serving for more than one beneficiary, their internal database system can be uploaded automatically under a defined setting. The system identifies best fit(s) in a prioritized matrix based upon entered information and/or search criteria, which is prioritized by the supervisor. System notifies the supervisor for the parties of match. Supervisor comments and decides on the level of the match and the direction of further interaction based on his/her social role with respect to beneficiary and/or professional expertise in a specific field. Supervisor makes the necessary comments and suggestions to the supervised entity. Parties match and detailed information is exchanged. Feedback from parties is retrieved from the supervised entitie(s) under the expertise of the supervisor. Supervisor is responsible for the feedback communication between supervised entity and the system using the following tools; on-line questioners and case specific assay reports. Information will be communicated back to the system. System retrieves feedback information and comments on which parties are a good match and which parties are not. The dynamic feature of the system enables a fast information update and enhanced learning in a neural network setting. Advice will be given back to the supervisors in the direction of better matches. Both parties, the supervisors and the system update themselves continuously.

The system stores and updates the information regarding the profiles of the beneficiaries and the use of the system, under the consent of the supervisor(s). Under the supervisors consent, accumulated information and records can be exchanged with third party experts and re searches for the mutual benefit of all parties.

Prefferred embodiments of the invention in terms of supervisor and supervised entity (beneficiary) pairs are as listed in Table I. and are not intended to limit the invention thereto.

Referring now to the drawings in general, the illustrations are for the purpose of describing a preferred embodiment of the invention and are not intended to limit the invention thereto.

Table I.

Is a list of potential supervisors and supervised entity pairs. Described pairs are within the application of the invention and are not intended to limit the invention.

TABLE 1

| Supervisors: | Beneficiaries (Supervised Entities): |
|---|---|
| Doctor | Patient |
| Lawyer | Client |
| Teacher | Student |
| Mentor | Student |
| Administrator | Candidate Applicant |
| Pharmacogenomics Expert | Patient and/or predisposed individual |
| Genetic Consultant | Patient and/or predisposed individual |
| Real estate Agent | Client (Buyer and/or Seller) |
| Parent | Child |
| Adult Child | Elderly Parent |
| Pet Owner | Pet |
| Police | Prisoner and/or Suspect |
| Fortune Teller | Client |
| Expert Marketing Researcher | Marketing Company |
| Car Dealer | Car Buyer/Seller |
| Antique Expert | Antique enthusiast |
| Immunologist | Organ Donor and/or Recipient |
| (transplantation expert) | |
| IRS expert | Citizen |
| Census Buro Expert | Citizen |
| INS official | Applicant |
| Consultant | Client |
| Sports Coach (Basketball Coach) | Sports Player (Basketball Player) |
| Tourist Guide | Tourist |
| Baby Sitter | Child |
| Accountant | Client |

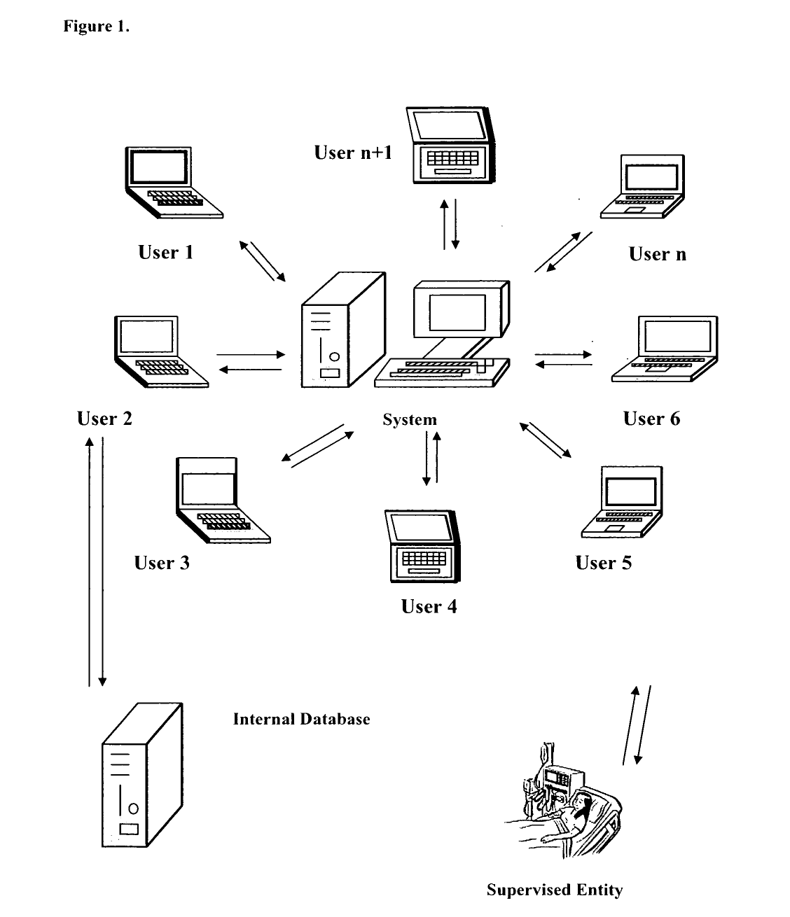

FIG. 1. is a particularly advantageous embodiment of the invention illustrated. Main server represents the “supervisory internet system”. Individual users represent supervisory entities using their professional or social skills to access information in the system for the use of the beneficiary, the supervised entity. User 2 represents a particular supervisor employing his/her internal database to serve to multiple users. The system provides routes of directed communication with other parties.

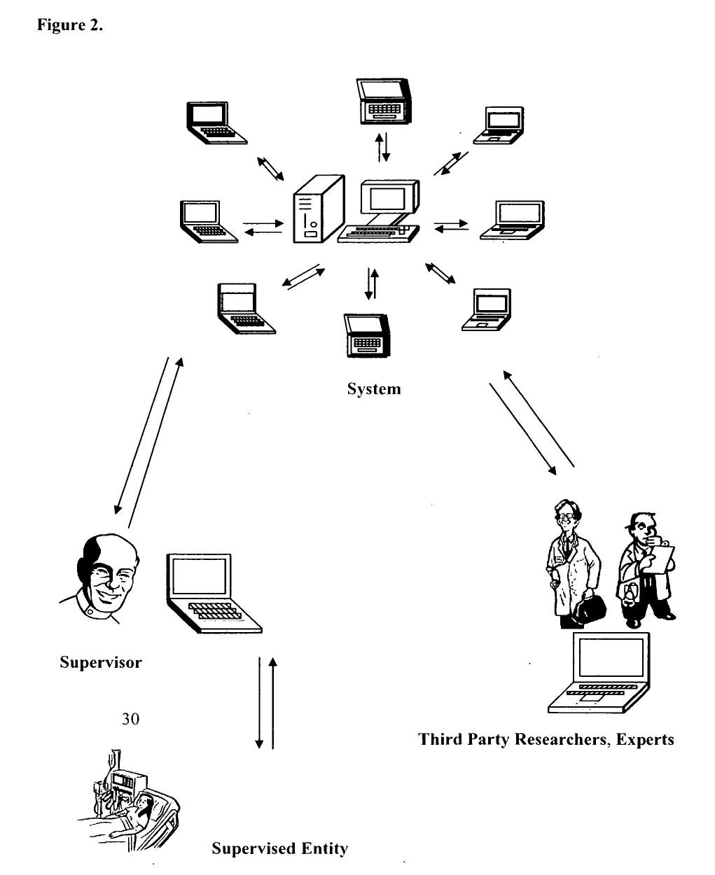

FIG. 2. is a schematic view of the invention, showing all the three parties involved in system functioning with the aim of serving the beneficiary. Supervisor(s) evaluate, frame and communicate information regarding the beneficiary. The system searches matching information and informs the supervisor. The supervisor makes the necessary decisions for the beneficiary and gets back to the system with comments. The system stores all the information and records of information exchange processes under the informed consent of the supervisor. Third parties can access this information and can communicate further according to the given consent by the supervisor.

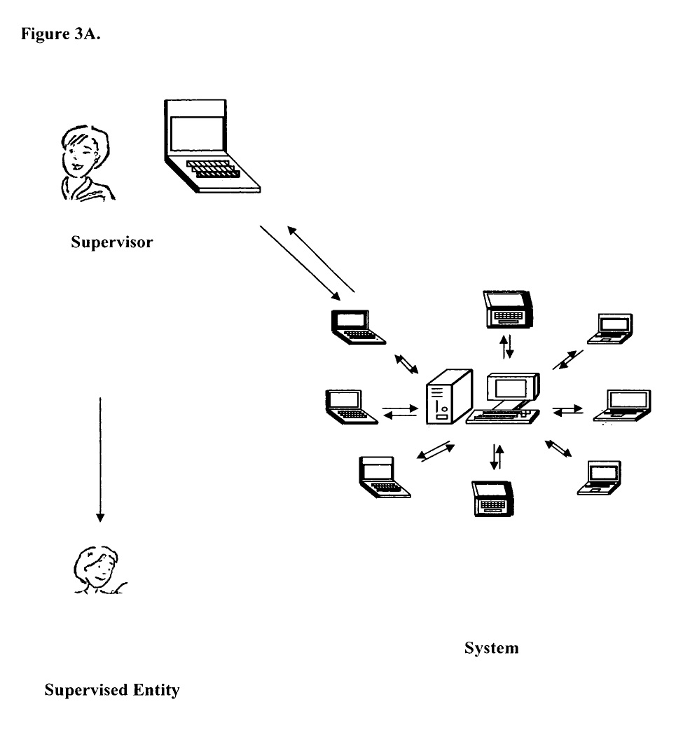

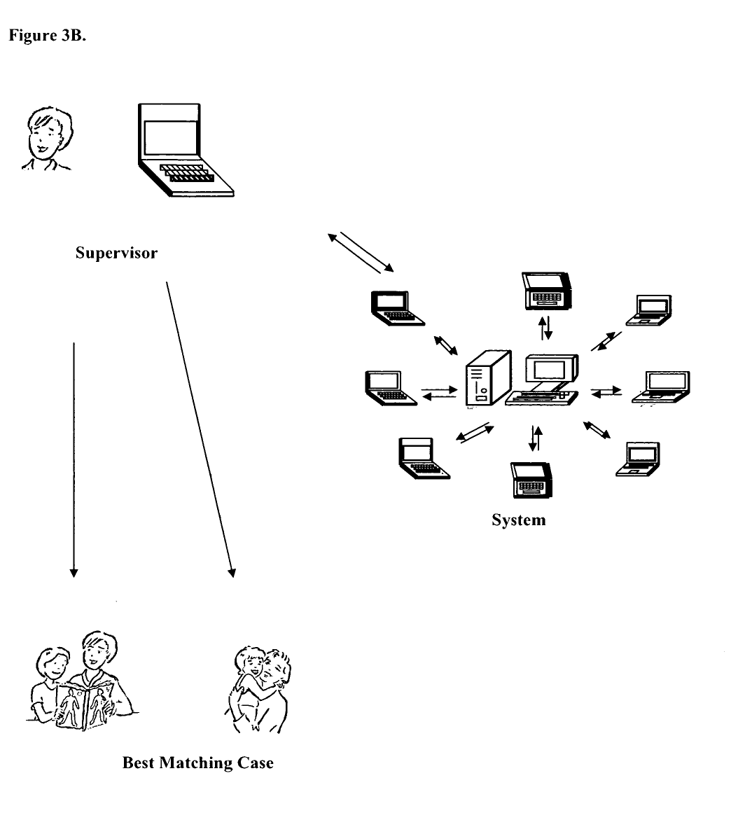

FIGS. 3A and B. is a diagrammatic view of the invention and its application in the social arena. Supervisory parents are using the system to search for a friend for their children. Parents put their children's profile with additional information about their family. Parents decide about the parameters of match framed search and design the search accordingly. Matched children with profiles of interest are contacted by the parents. After social interaction, parents feed back the system with information on the degree of match. The system as well as the parents updates themselves.

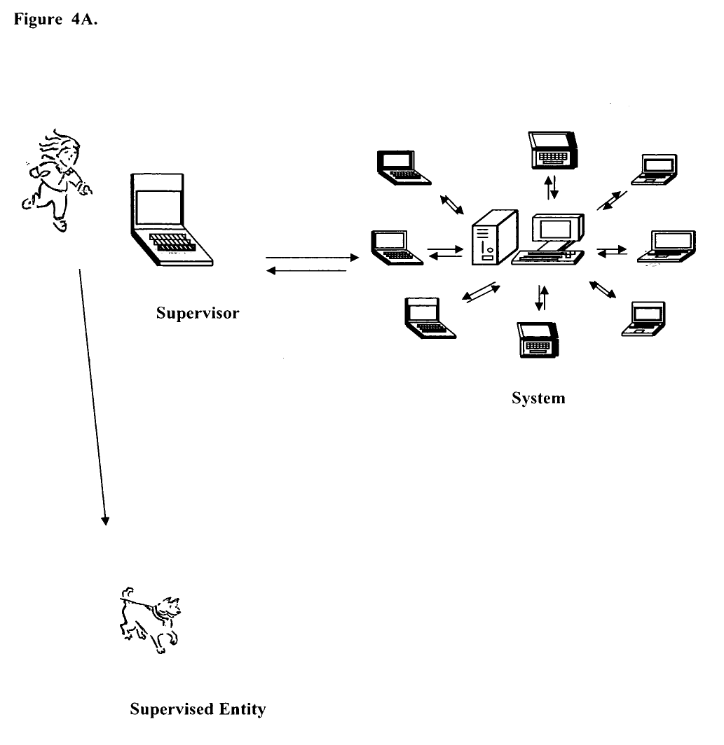

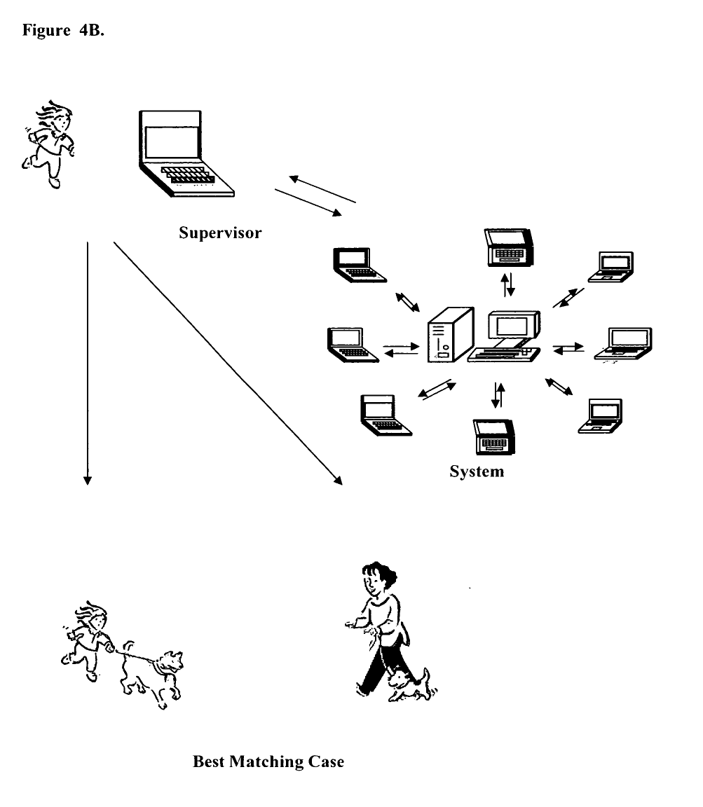

FIGS. 4A and B. is another diagrammatic view of the invention and its application in the social arena. Pet owners look up for pet-friends for their pets regarding social play, training and breeding purposes. Pet owners put their pets profile onto the system. By deciding on search parameters they direct the search on particular groups of pets. After getting the list of profiles pet owners contact other parties for social play, breading, and training purposes. Information regarding the social interaction is fed back to the system by the pet owners.

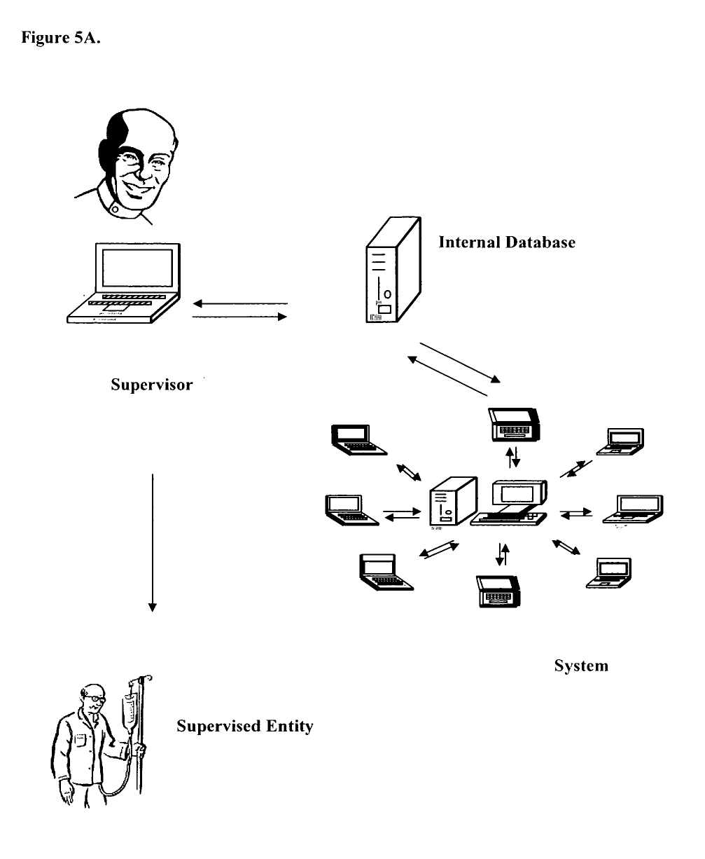

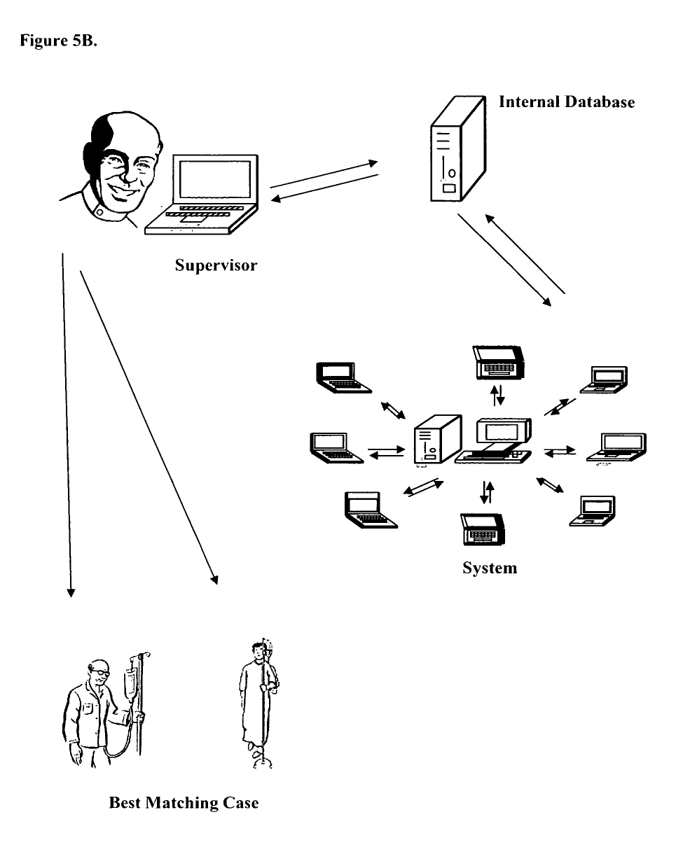

FIGS. 5A and B. is a schematic representation of the application where professional expertise is required. The doctor is using the system to retrieve information to treat his/her patient. Doctor puts the patients profile including the specifics of the medical condition on to the server. Using the doctor defined criteria the system searches for matching profiles. Matching cases are provided to the doctor to design the best treatment. Matching patients can meet for rehabilitation purposes and doctors of matching parties can exchange professional information. Both the doctors and the system update themselves on the matching case information.

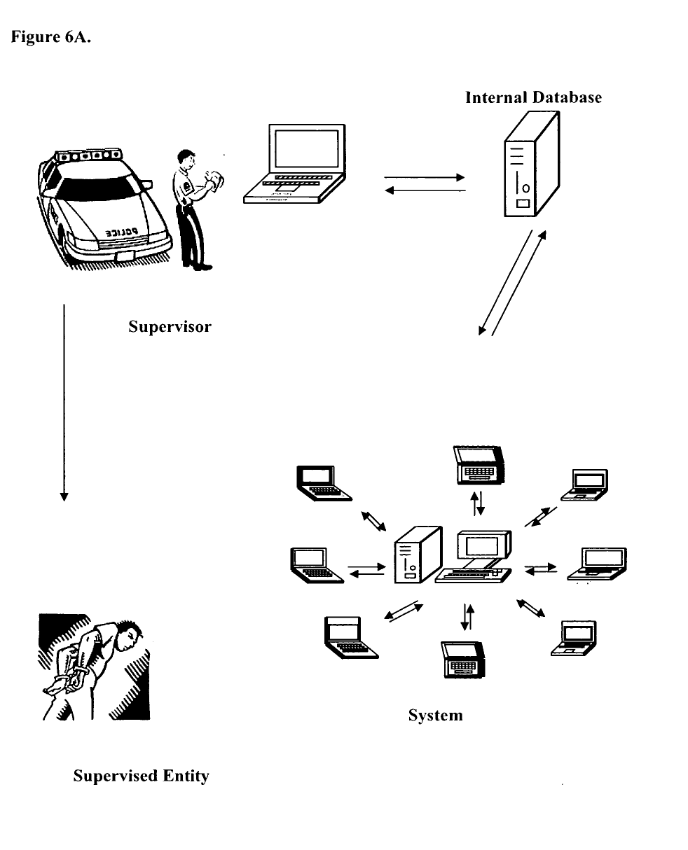

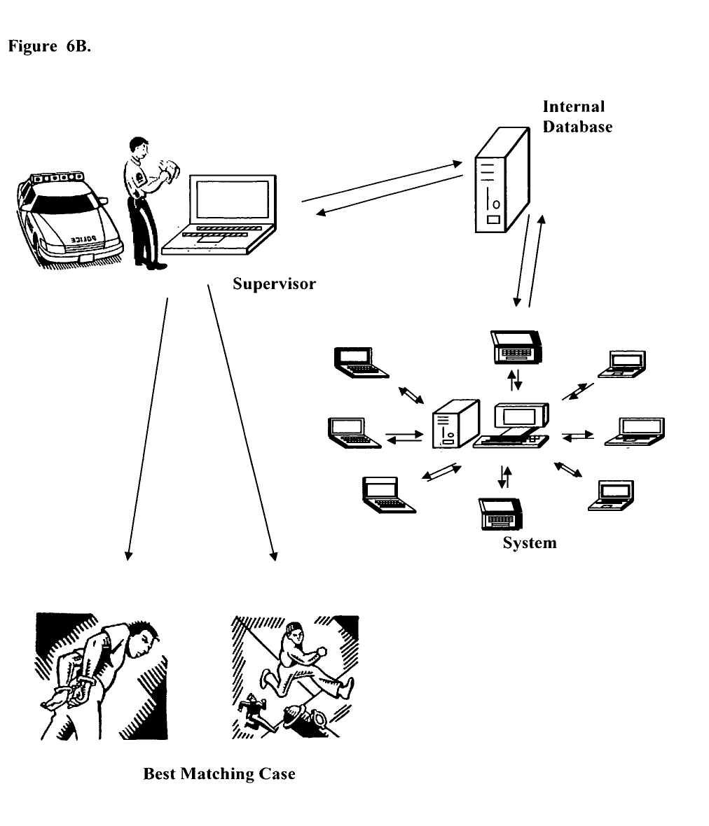

FIGS. 6A and B. is another diagrammatic representation of the system application, where the supervisor, the police is using the system to obtain framed information to elucidate a suspects case. System is provided with a profile of the suspect under the expertise of the police. The matching profiles are retrieved. Police continues with further investigation on the matching profiles. The case is identified, other police officers on the matching case are contacted regarding the suspects case and hidden connections between cases are found. The suspect and matching criminals can meet socially for rehabilitation purposes and/or for face to face interviews. Information is fed back to the system. Both the police and the system update themselves accordingly.

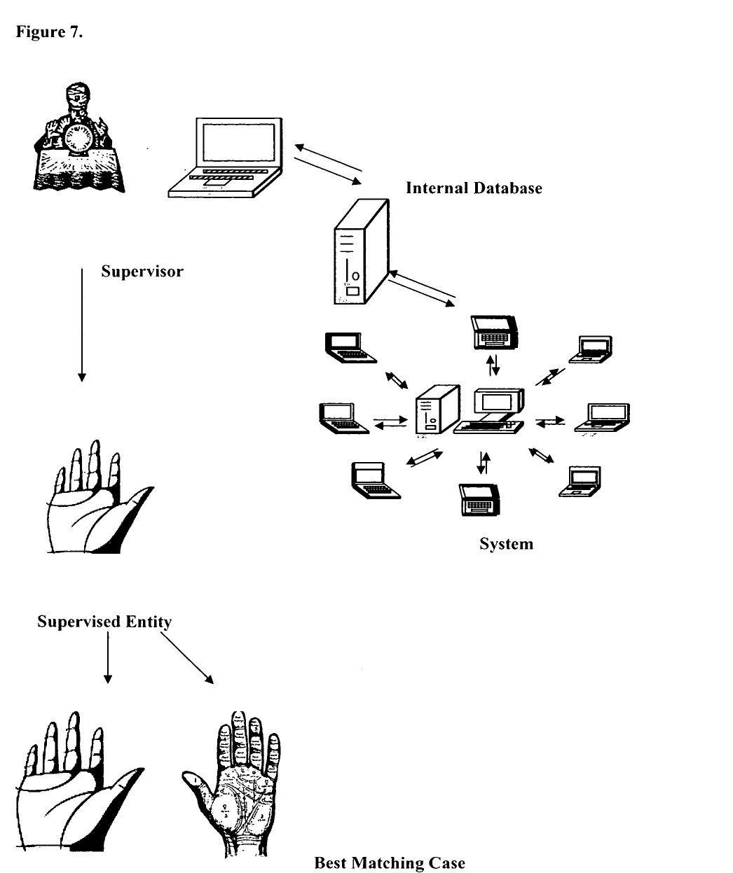

FIG. 7. is a schematic representation of the systems application, where the supervisor, the fortune teller uses framed palm profiles and associated life stories to retrieve information regarding future prediction for his/her clients. Fortune teller organizes the profile of the client including a palm picture and a brief life story. The profile is matched against other profiles including elder persons. A prediction is made based on matching palm signs and associated life stories. Elder people's matching profiles are used to make the prediction for younger people. Parties are informed about the match for potential social activity. Information is fed back to the system to update the matching system. Supervisors and the system contact matching parties periodically and obtain real life stories to compare with the forecasted prediction. The system updates itself continuously under the expertise of the supervisor.

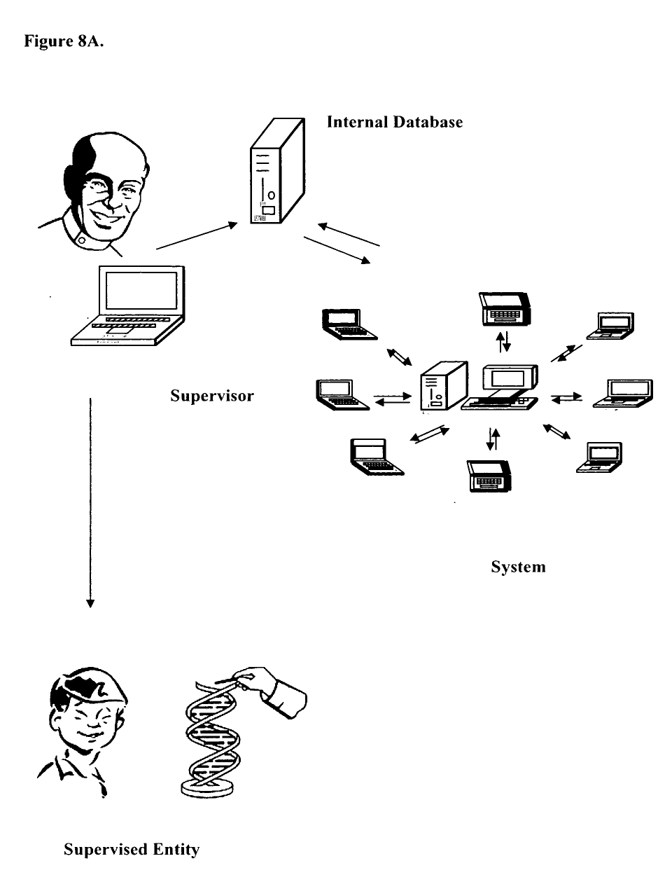

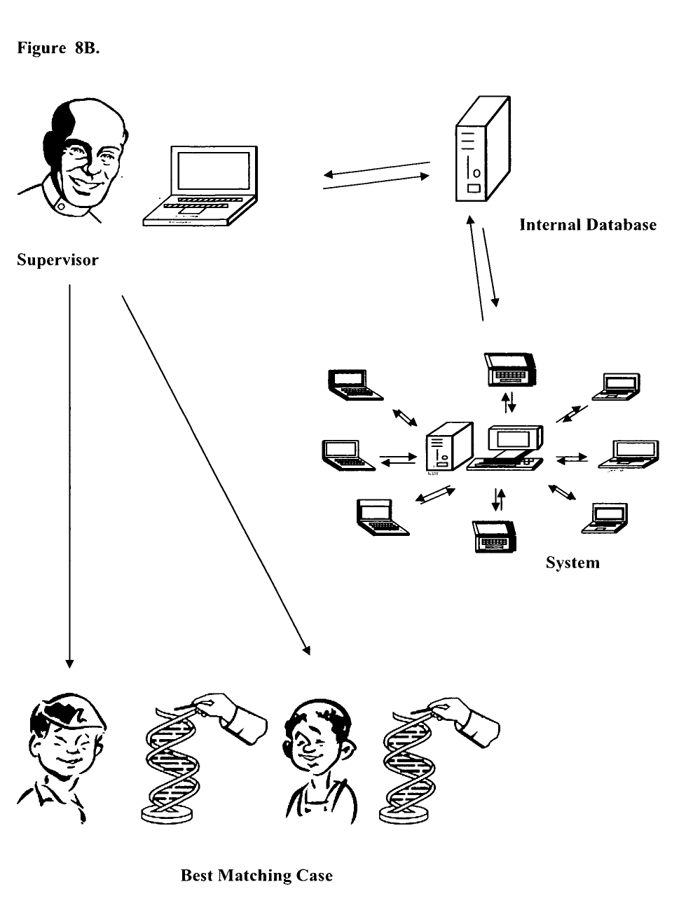

FIGS. 8A and B. is a another schematic representation of the application in medical profession. The supervisory pharmacogenomics expert is using individual gene expression profiles to to fine tune the best individualized patient treatment. The supervisor, organizes and puts the patients profile including patterns of individual specific gene expression and specifics of the medical condition onto the system. The system matches other cases. Treatment of the disease is designed according to other matching profiles. Matching patients can meet for social activity and rehabilitation purposes and can mutually help each other with coping skills. The supervisor informs the system about the match. Both the system and the supervisory expert update themselves.

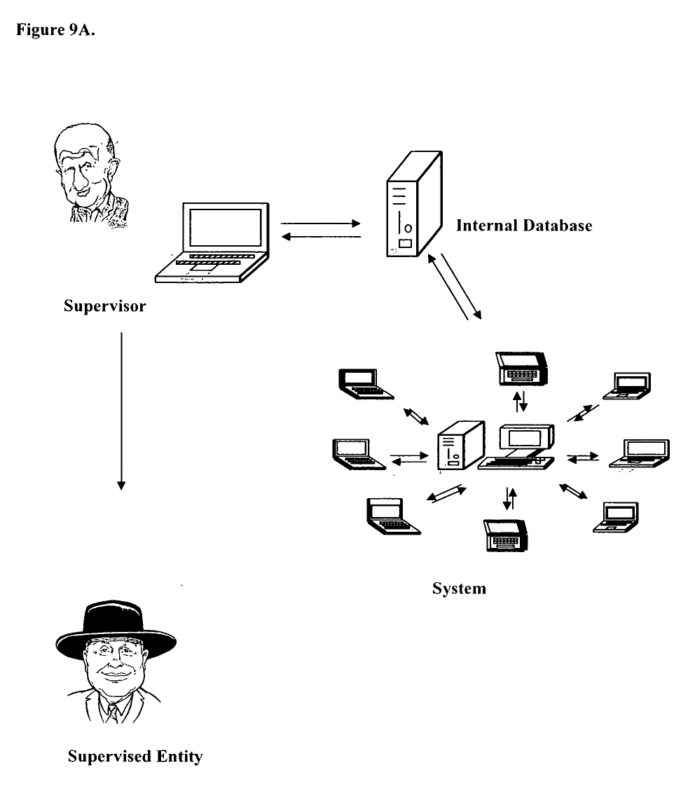

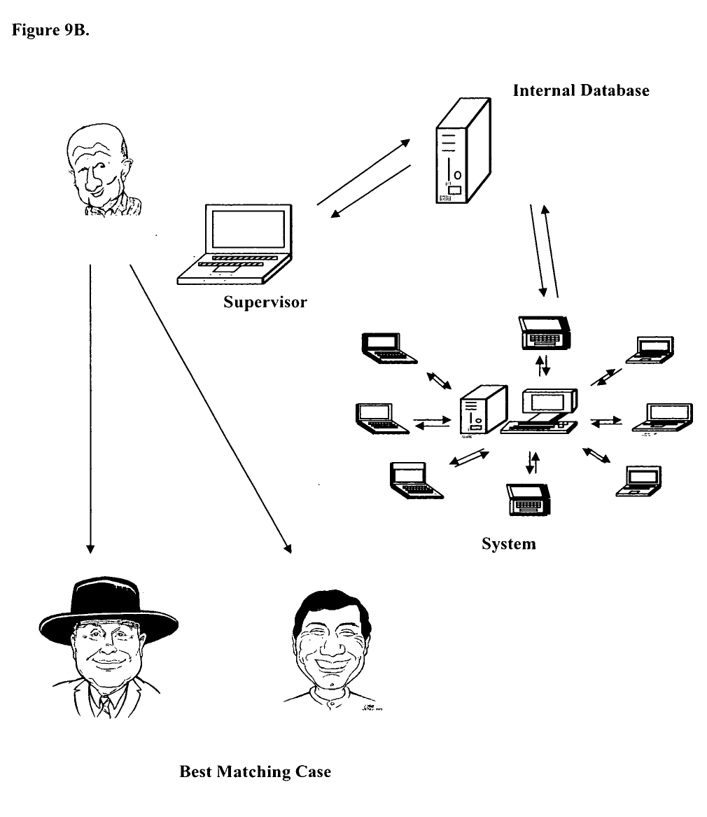

FIGS. 9A and B. is another diagrammatic representation of professional application of the system. The supervisor, a marketing consultant is depicted here using the system to search for information for his/her clients. The marketing consultant forms the marketing profile of the supervised entity, the client. The profile is matched against other profiles in the system according to determined criteria by the expert. Matching cases are analyzed by the expert and consultancy service is given accordingly. Matching parties can meet individually to exchange further information regarding their strategies. The supervisor updates the system with information about the match. Both the system and the supervisor update themselves.

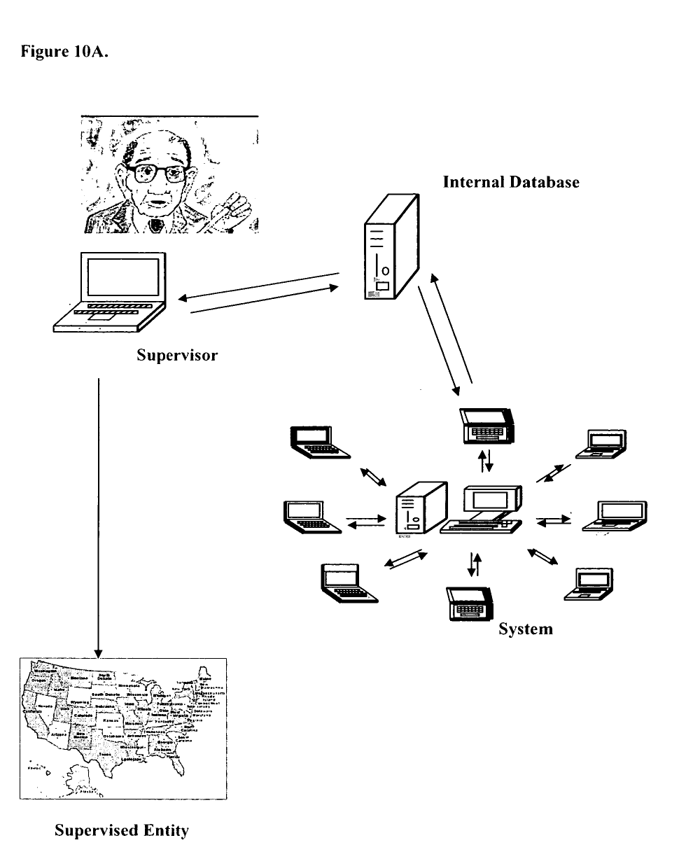

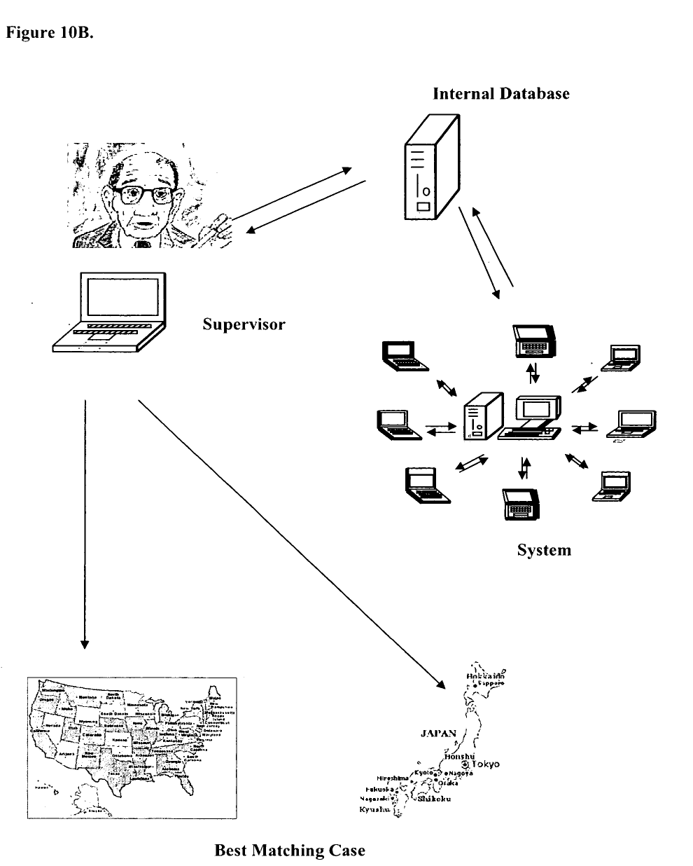

FIGS. 10A and B. is a depiction of another professional application of the system. The supervisor, chief of economy is using the system to mine information for his client. In that case economic profile of United States of America is searched against a set of economic profiles and the matching case, Japan is compared on multiple criteria. Experts of economy from both counties can meet for information exchange. The supervisor updates the system on the match. Both the supervisor and the system update themselves.

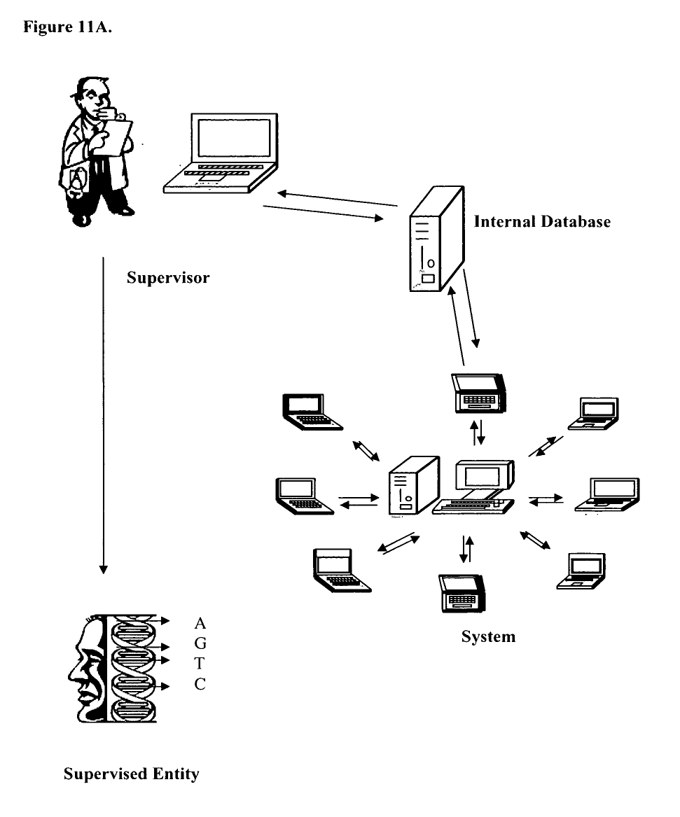

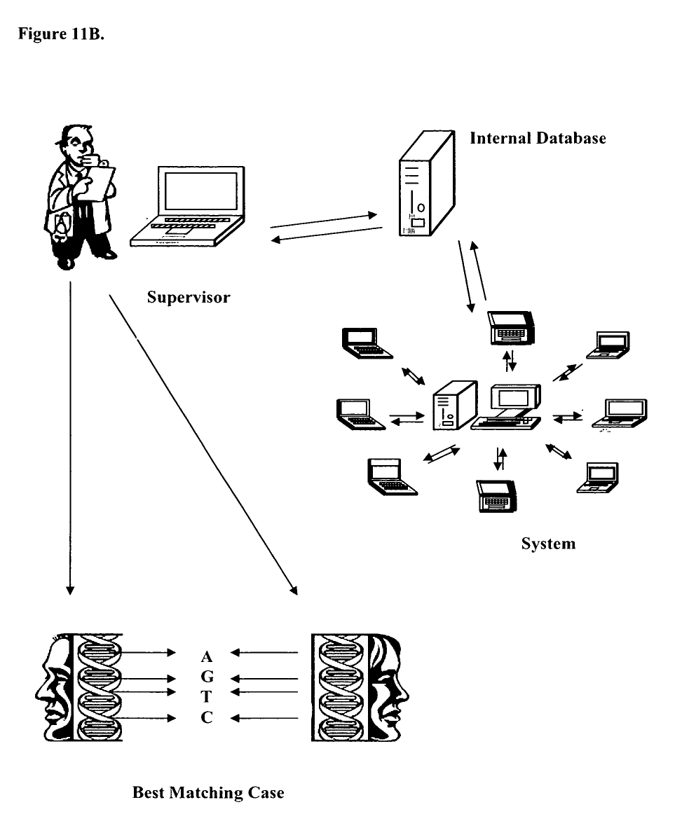

FIGS. 11A and B. is a schematic representation of a medical application. The supervisor, genetic counselor obtains the Single Nucleotide Polymorphism (SNP) profile of the patient with an associated disease story. The information is put into a profile and is matched against a set of profiles in the systems database. Matching profiles are evaluated by the expert supervisor. Disease treatment and prevention strategies are determined accordingly. Information is fed back to the system. Dynamic system learns and uses the information to improve the SNP-disease mapping process and gets back to the supervisor with lessons learned.

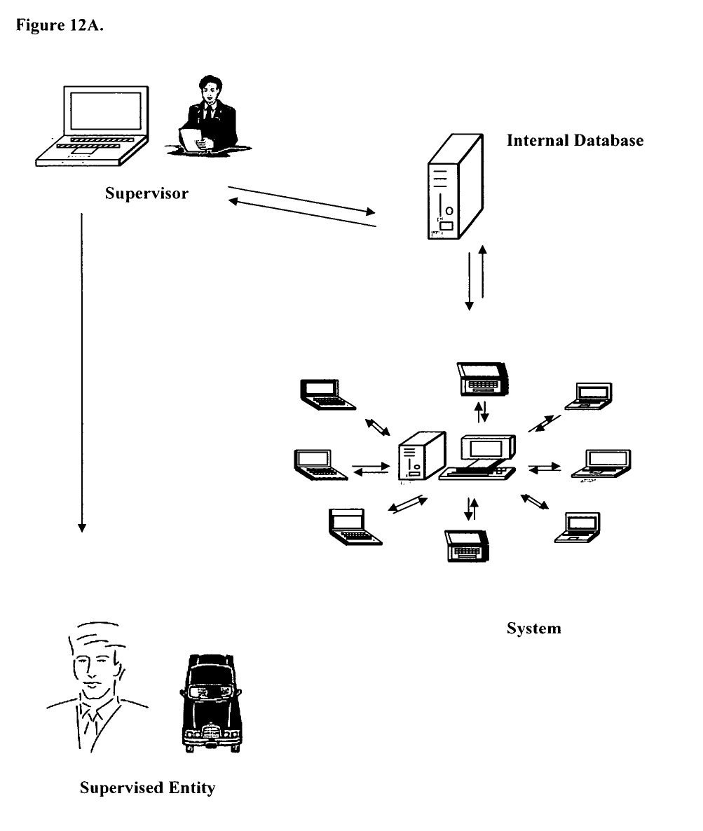

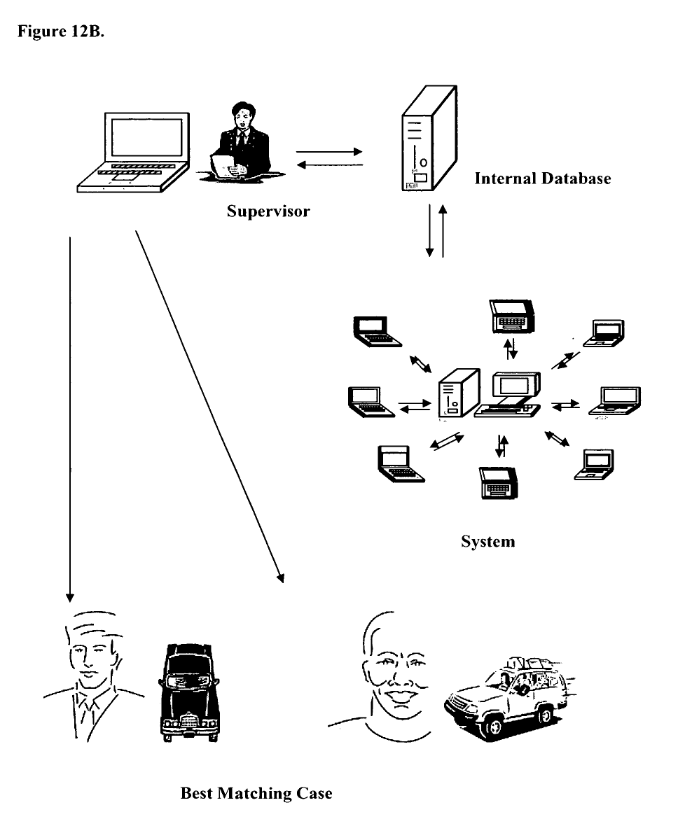

FIGS. 12A and B. is a schematic representation of commercial application of the system, where the supervisor, a professional car dealer is using the system to retrieve information regarding buying and selling suitable cars in favor of the beneficiaries, the costumers. The supervisor examines the buyer or seller profile of his/her clients and puts them onto the system. System matches buyer and seller profiles according to criteria determined by the car dealer, the supervisor. Matched parties are informed and the transaction is completed under the supervision of the expert. Matching parties exchange contact information for sharing their enthusiasm. The supervisor informs the system about the match. Both the supervisor and the system update themselves.

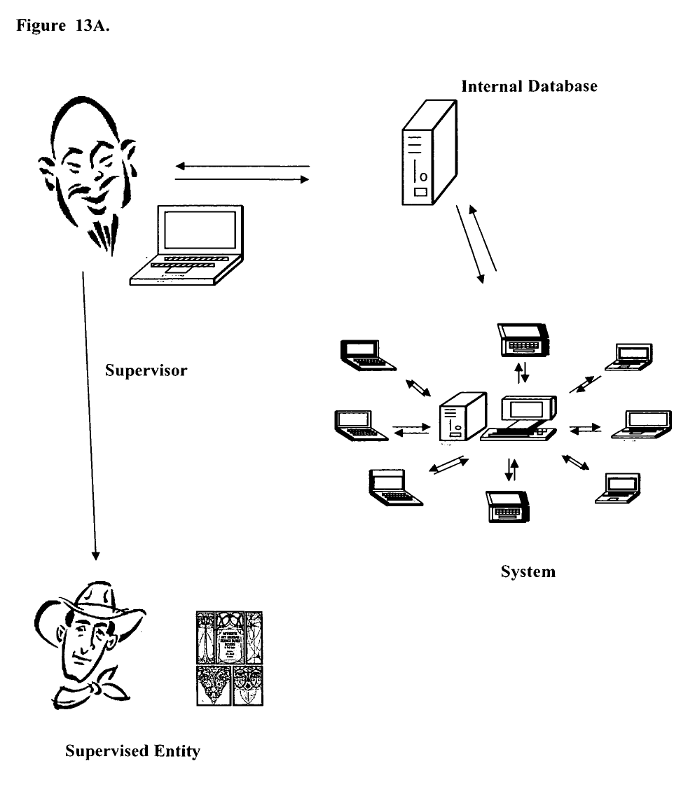

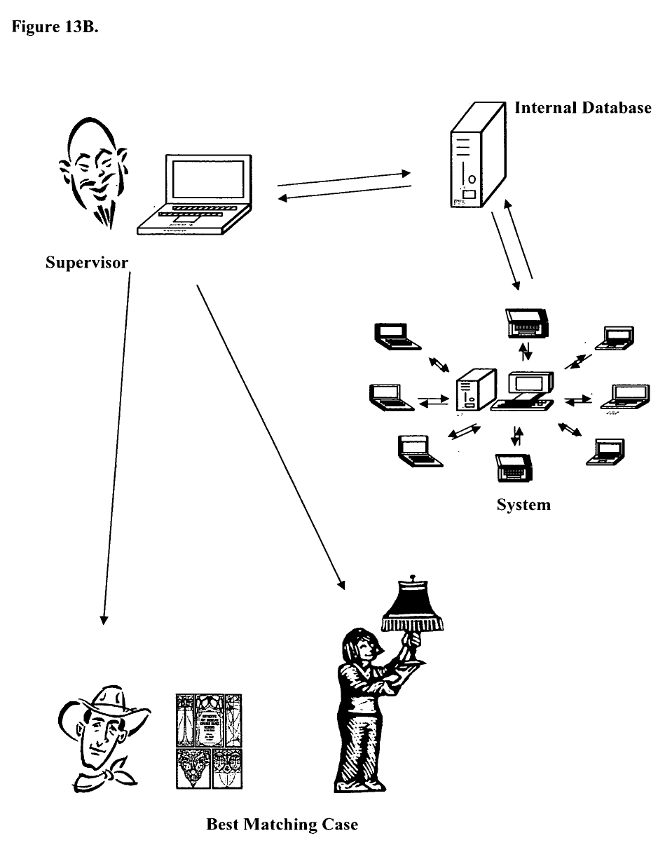

FIGS. 13A and B. is a depiction of a commercial application. The supervisor, an antique expert is using the system to find requested items and/or to sell items of interest as a part of her service for the supervised entity, the costumer. The supervisor examines the buyer or seller profile of his/her clients and puts them onto the system. System matches buyer profiles and seller's profiles according to criteria determined by the supervisor, the antique expert. Matched parties are informed and the transaction is performed under the supervision of the expert. Matching parties exchange contact information for sharing their hobbies. The supervisor informs the system about the match. The system and the supervisory expert update them selves.

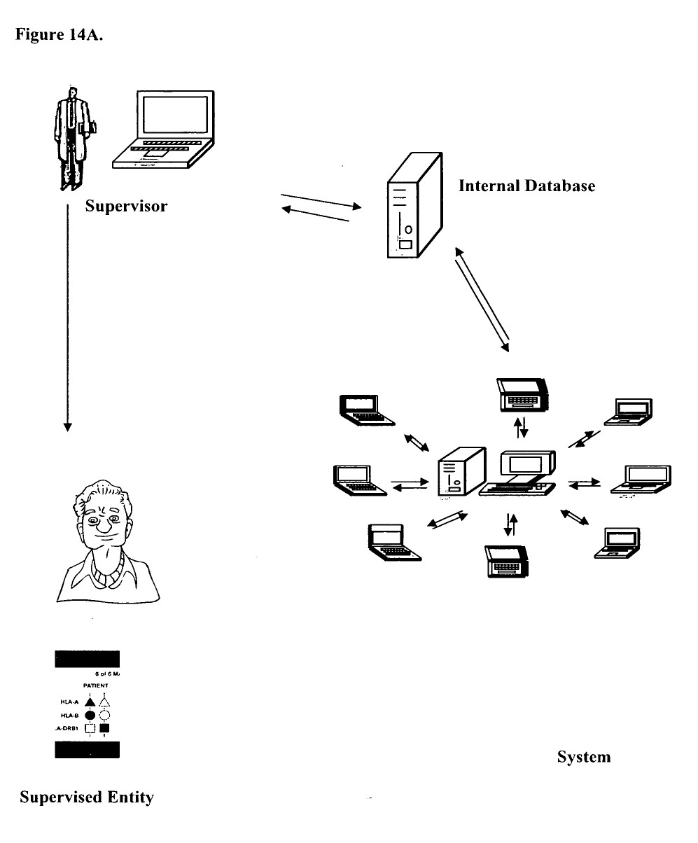

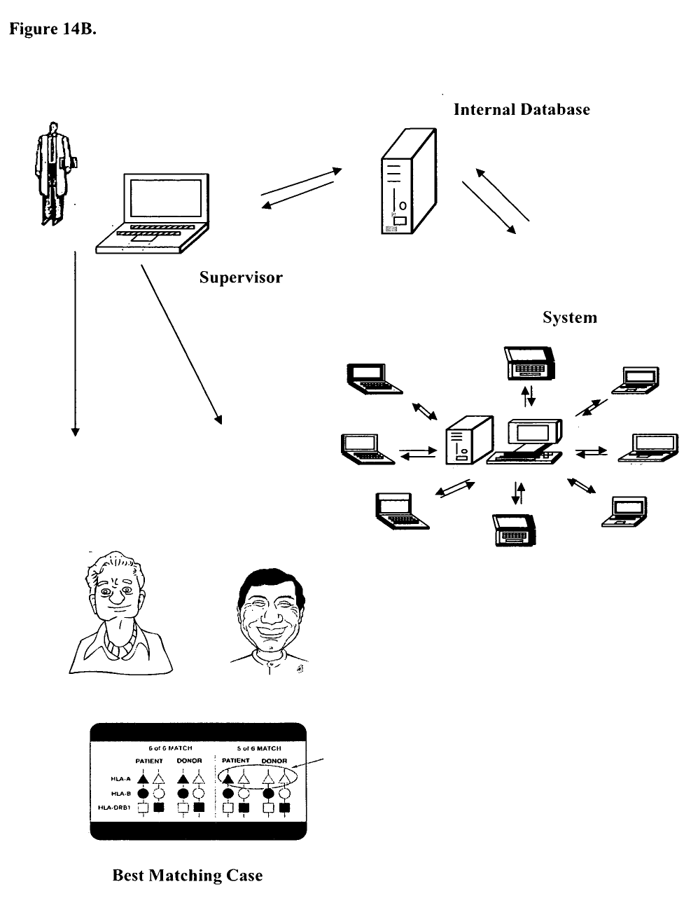

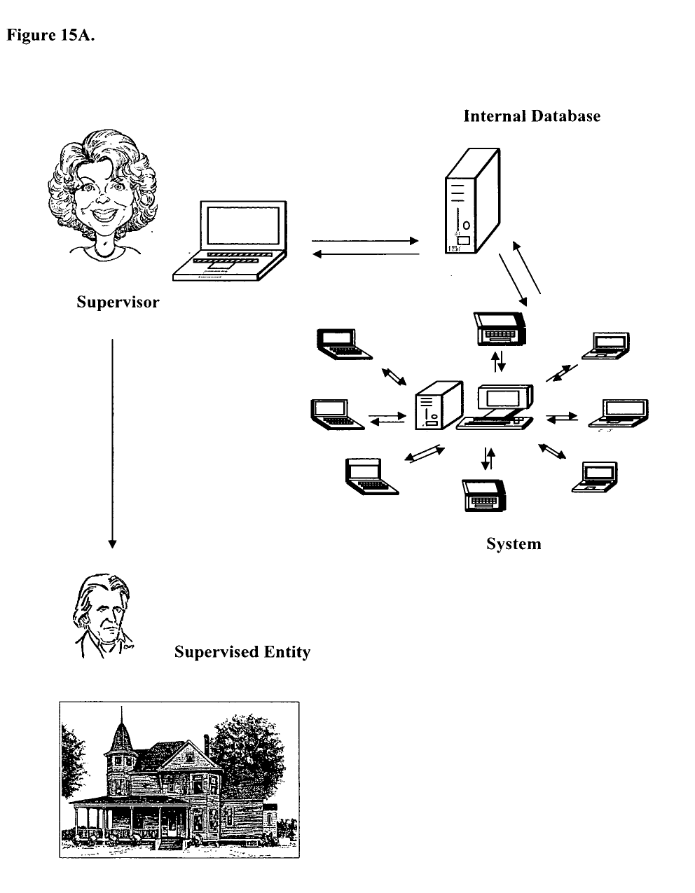

FIGS. 14A and B. is another representation of the invention's application in the medical filed. The supervisor is an immunologist an expert of organ transplantation. Antigen types are determined by the supervisor and the beneficiaries (supervised entities, donor or recipient) profile is prepared accordingly. The profile is matched against others in the system. Best matching party (donor/or recipient) is contacted. Organ transplantation is organized. Parties can exchange information for social rehabilitation and coping purposes. The supervisor informs the system about the match. Both the system and the supervisor update themselves.

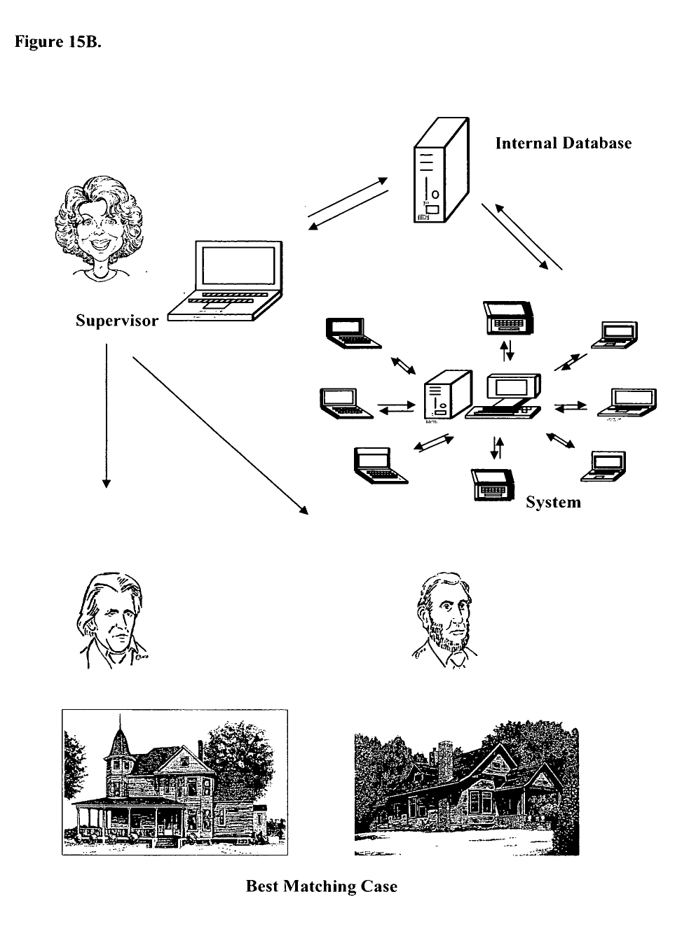

FIGS. 15A and B. This is a schematic depiction of the application in a commercial filed. The supervisor is a real estate agent. The supervisor prepares the client profile according to her expertise. The profile is matched against other profiles in the system. Best matching buyer and seller profiles are communicated back to the clients, matching parties. The transaction is completed under the consent of the supervisor, the real estate agent. The supervisor updates the system with the match.

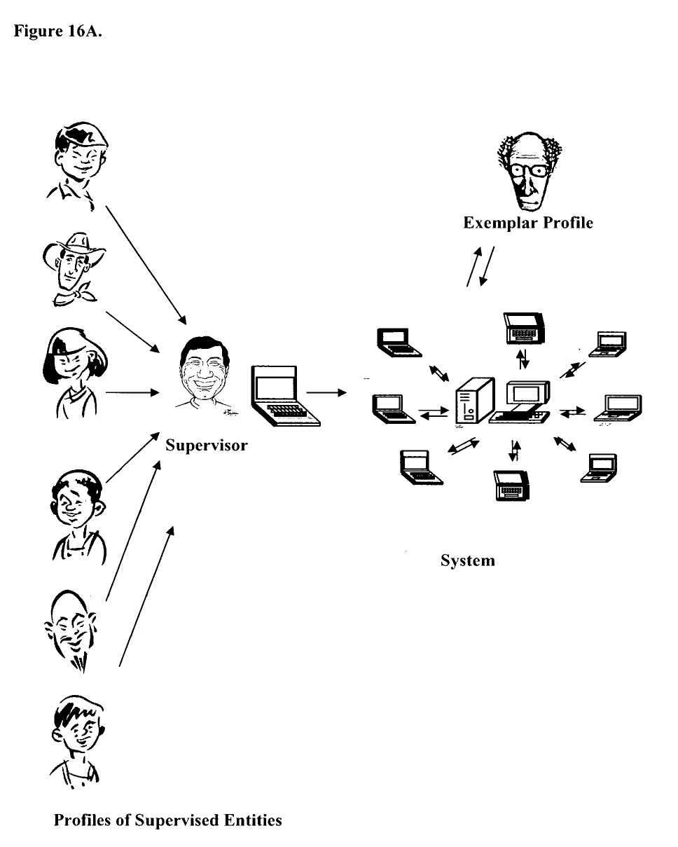

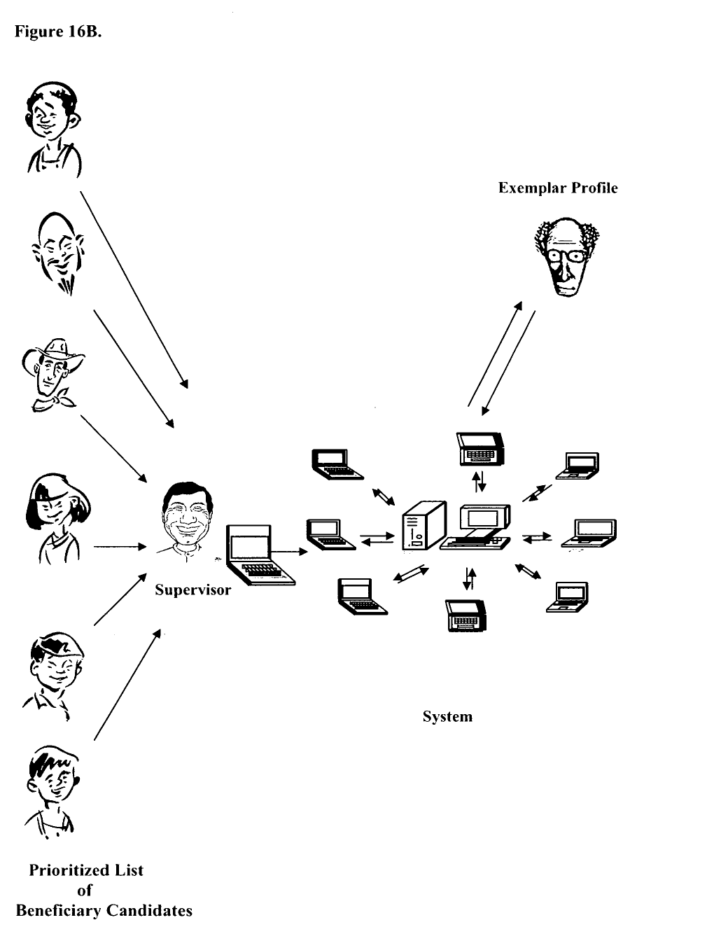

FIGS. 16A and B. is a view of the reverse matching concept. A set of profiles of supervised entitities are matched to an exemplar profile in the systems database. The profiles are organized in the order of their degree of match. The supervisor evaluates the positive and negative points on the profiles with respect to the exemplar profile and informs the supervised entities accordingly. The supervisor also informs the system about the match.

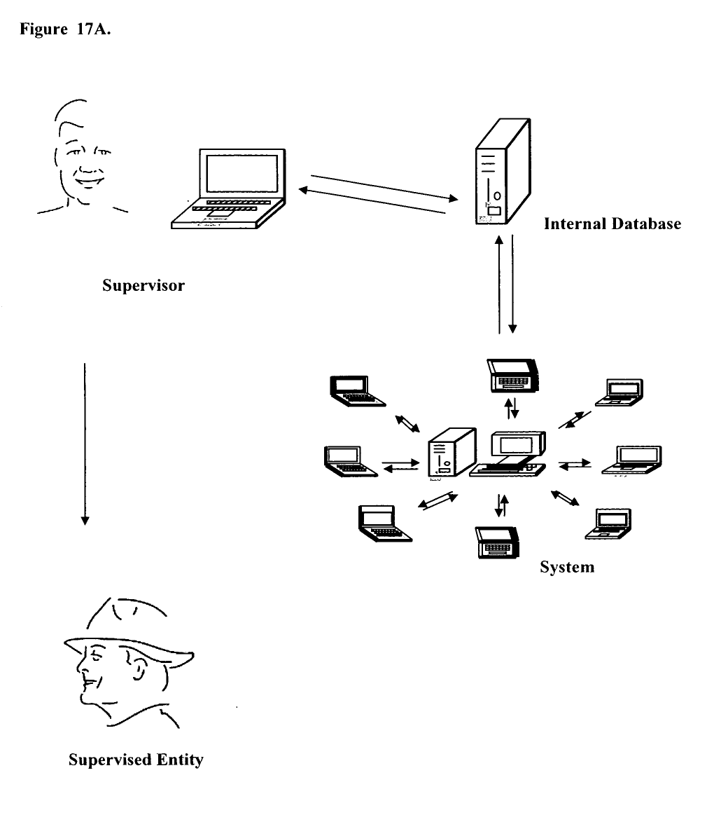

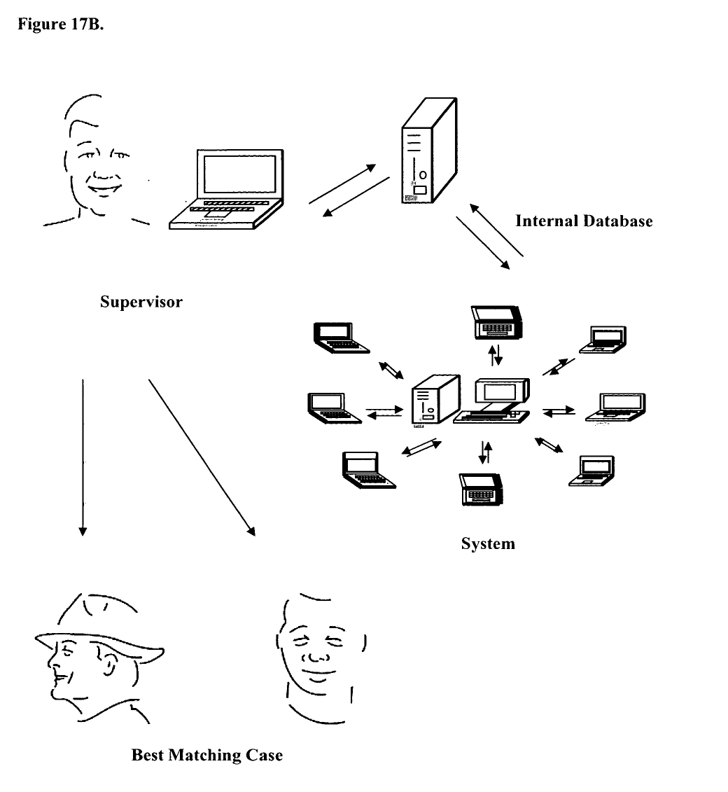

FIGS. 17A and B. is a schematic depiction of an administrative application. The supervisor, the administrator of applications receives and organizes the applications into profiles. The applications of the candidates are matched against a set of employee, student profiles. The administrator makes the decision about the candidates accordingly. Matching parties contact each other for future improvement on behalf of the candidate. The supervisor informs the system about the match. Both the supervisor and the system update themselves. For the candidate selection, reverse matching tool is employed. The pool of candidate's profiles is matched against a particular high achieving student and/or employer. Matching candidates are prioritized in a matrix and selection procedure is done accordingly. Certain modifications and improvements will occur to those skilled in the art upon a reading of the foregoing description. All modifications and improvements have been deleted herein for the sake of conciseness and readability but are properly within the scope of the following claims.

FIG. 1. is a particularly advantageous embodiment of the invention illustrated. Main server represents the “supervisory internet system”. Individual users represent supervisory entities using their professional or social skills to access information in the system for the use of the beneficiary, the supervised entity. User 2 represents a particular supervisor employing his/her internal database to serve to multiple users. The system provides routes of directed communication with other parties.

FIG. 2. is a schematic view of the invention, showing all the three parties involved in system functioning with the aim of serving the beneficiary. Supervisor(s) evaluate, frame and communicate information regarding the beneficiary. The system searches matching information and informs the supervisor. The supervisor makes the necessary decisions for the beneficiary and gets back to the system with comments. The system stores all the information and records of information exchange processes under the informed consent of the supervisor. Third parties can access this information and can communicate further according to the given consent by the supervisor.

FIGS. 3A and B. is a diagrammatic view of the invention and its application in the social arena. Supervisory parents are using the system to search for a friend for their children. Parents put their children's profile with additional information about their family. Parents decide about the parameters of match framed search and design the search accordingly. Matched children with profiles of interest are contacted by the parents. After social interaction, parents feed back the system with information on the degree of match.

The system as well as the parents updates themselves.

FIGS. 4A and B. is another diagrammatic view of the invention and its application in the social arena. Pet owners look up for pet-friends for their pets regarding social play, training and breeding purposes. Pet owners put their pets profile onto the system. By deciding on search parameters they direct the search on particular groups of pets. After getting the list of profiles pet owners contact other parties for social play, breading, and training purposes. Information regarding the social interaction is fed back to the system by the pet owners.

FIGS. 5A and B. is a schematic representation of the application where professional expertise is required. The doctor is using the system to retrieve information to treat his/her patient. Doctor puts the patients profile including the specifics of the medical condition on to the server. Using the doctor defined criteria the system searches for matching profiles. Matching cases are provided to the doctor to design the best treatment. Matching patients can meet for rehabilitation purposes and doctors of matching parties can exchange professional information. Both the doctors and the system update themselves on the matching case information.

FIGS. 6A and B. is another diagrammatic representation of the system application, where the supervisor, the police is using the system to obtain framed information to elucidate a suspects case. System is provided with a profile of the suspect under the expertise of the police. The matching profiles are retrieved. Police continues with further investigation on the matching profiles. The case is identified, other police officers on the matching case are contacted regarding the suspects case and hidden connections between cases are found. The suspect and matching criminals can meet socially for rehabilitation purposes and/or for face to face interviews. Information is fed back to the system. Both the police and the system update themselves accordingly.

FIG. 7. is a schematic representation of the systems application, where the supervisor, the fortune teller uses framed palm profiles and associated life stories to retrieve information regarding future prediction for his/her clients. Fortune teller organizes the profile of the client including a palm picture and a brief life story. The profile is matched against other profiles including elder persons. A prediction is made based on matching palm signs and associated life stories. Elder people's matching profiles are used to make the prediction for younger people. Parties are informed about the match for potential social activity. Information is fed back to the system to update the matching system. Supervisors and the system contact matching parties periodically and obtain real life stories to compare with the forecasted prediction. The system updates itself continuously under the expertise of the supervisor.

FIGS. 8A and B. is another schematic representation of the application in medical profession. The supervisory pharmacogenomics expert is using individual gene expression profiles to to fine tune the best individualized patient treatment. The supervisor, organizes and puts the patients profile including patterns of individual specific gene expression and specifics of the medical condition onto the system. The system matches other cases. Treatment of the disease is designed according to other matching profiles. Matching patients can meet for social activity and rehabilitation purposes and can mutually help each other with coping skills. The supervisor informs the system about the match. Both the system and the supervisory expert update themselves.

FIGS. 9A and B. is another diagrammatic representation of professional application of the system. The supervisor, a marketing consultant is depicted here using the system to search for information for his/her clients. The marketing consultant forms the marketing profile of the supervised entity, the client. The profile is matched against other profiles in the system according to determined criteria by the expert. Matching cases are analyzed by the expert and consultancy service is given accordingly. Matching parties can meet individually to exchange further information regarding their strategies. The supervisor updates the system with information about the match. Both the system and the supervisor update themselves.

FIGS. 10A and B. is a depiction of another professional application of the system. The supervisor, chief of economy is using the system to mine information for his client. In that case economic profile of United States of America is searched against a set of economic profiles and the matching case, Japan is compared on multiple criteria. Experts of economy from both counties can meet for information exchange. The supervisor updates the system on the match. Both the supervisor and the system update themselves.

FIGS. 11A and B. is a schematic representation of a medical application. The supervisor, genetic counselor obtains the Single Nucleotide Polymorphism (SNP) profile of the patient with an associated disease story. The information is put into a profile and is matched against a set of profiles in the systems database. Matching profiles are evaluated by the expert supervisor. Disease treatment and prevention strategies are determined accordingly. Information is fed back to the system. Dynamic system learns and uses the information to improve the SNP-disease mapping process and gets back to the supervisor with lessons learned.

FIGS. 12A and B. is a schematic representation of commercial application of the system, where the supervisor, a professional car dealer is using the system to retrieve information regarding buying and selling suitable cars in favor of the beneficiaries, the costumers. The supervisor examines the buyer or seller profile of his/her clients and puts them onto the system. System matches buyer and seller profiles according to criteria determined by the car dealer, the supervisor. Matched parties are informed and the transaction is completed under the supervision of the expert. Matching parties exchange contact information for sharing their enthusiasm. The supervisor informs the system about the match. Both the supervisor and the system update themselves.

FIGS. 13A and B. is a depiction of a commercial application. The supervisor, an antique expert is using the system to find requested items and/or to sell items of interest as a part of her service for the supervised entity, the costumer. The supervisor examines the buyer or seller profile of his/her clients and puts them onto the system. System matches buyer profiles and seller's profiles according to criteria determined by the supervisor, the antique expert. Matched parties are informed and the transaction is performed under the supervision of the expert. Matching parties exchange contact information for sharing their hobbies. The supervisor informs the system about the match.

The system and the supervisory expert update them selves.

FIGS. 14A and B. is another representation of the invention's application in the medical filed. The supervisor is an immunologist an expert of organ transplantation. Antigen types are determined by the supervisor and the beneficiaries (supervised entities, donor or recipient) profile is prepared accordingly. The profile is matched against others in the system. Best matching party (donor/or recipient) is contacted. Organ transplantation is organized. Parties can exchange information for social rehabilitation and coping purposes. The supervisor informs the system about the match. Both the system and the supervisor update themselves.

FIGS. 15A and B. This is a schematic depiction of the application in a commercial filed. The supervisor is a real estate agent. The supervisor prepares the client profile according to her expertise. The profile is matched against other profiles in the system. Best matching buyer and seller profiles are communicated back to the clients, matching parties. The transaction is completed under the consent of the supervisor, the real estate agent. The supervisor updates the system with the match.

FIGS. 16A and B. is a view of the reverse matching concept. A set of profiles of supervised entitities are matched to an exemplar profile in the systems database. The profiles are organized in the order of their degree of match. The supervisor evaluates the positive and negative points on the profiles with respect to the exemplar profile and informs the supervised entities accordingly. The supervisor also informs the system about the match.

FIGS. 17A and B. is a schematic depiction of an administrative application. The supervisor, the administrator of applications receives and organizes the applications into profiles. The applications of the candidates are matched against a set of employee, student profiles. The administrator makes the decision about the candidates accordingly. Matching parties contact each other for future improvement on behalf of the candidate. The supervisor informs the system about the match. Both the supervisor and the system update themselves. For the candidate selection, reverse matching tool is employed. The pool of candidate's profiles is matched against a particular high achieving student and/or employer. Matching candidates are prioritized in a matrix and selection procedure is done accordingly.

What is claimed is:

1. A system for on-line matching between parties, the system comprising:
at least one server hosting a secure database and connected to a network over which at least one remote, authorized user can access the server through the network using at least one remote computer or network access device operable to communicate and interface with the server, the server further including software for matching a profile entered by the user on behalf of at least one beneficiary, wherein the profile predominantly relates directly to the at least one beneficiary, not the user.

2. The system of claim 1, wherein the user of the system is a supervisor and the at least one beneficiary is a supervised entity under the supervisor.

3. The system of claim 2, wherein the user is a parent and the beneficiary is a child.

4. The system of claim 1, wherein the matching is direct matching of the profiles related to the beneficiary and an unrelated party.

5. The system of claim 4, wherein the unrelated party includes a single individual.

6. The system of claim 4, wherein the unrelated party includes a group of individuals.

7. The system of claim 1, wherein the matching is one-way matching between one beneficiary and a single individual.

8. The system of claim 1, wherein the matching is multi-way matching.

9. The system of claim 8, wherein the multi-way matching includes matching between multiple parties.

10. The system of claim 8, wherein the multi-way matching provides for matching between the profile associated with one beneficiary to multiple candidate profiles.

11. The system of claim 8, wherein the multi-way matching provides for matching of multiple candidate profiles to one exemplar profile.

12. The system of claim 1, wherein the profile includes a plurality of factors.

13. The system of claim 12, wherein the factors are prioritized by the user.

14. The system of claim 13, wherein the matching is ranked by relevance to the prioritization.

15. The system of claim 13, wherein the priorities are based upon responses to a questionnaire.

16. The system of claim 15, wherein the priorities are based upon a predetermined number of top priorities.

17. The system of claim 1, wherein the matching is reverse-matching.

18. The system of claim 1, wherein the reverse-matching is by a pool of candidates for a single job opportunity.

19. The system of claim 1, wherein the beneficiary is not capable directly using the system.

20. The system of claim 1, wherein the beneficiary is selected from the group consisting of children, pets, elderly persons, job applicants, and combinations thereof.

21. The system of claim 1, wherein the profile further includes a plurality of factors and characteristics associated with either the beneficiary or the user.

22. The system of claim 21, wherein the profile further includes a first factor set associated primarily with parent.

23. The system of claim 22, wherein the first factor set includes economic status, profession, education level, religious background, nationality, and combinations thereof.

24. The system of claim 21, wherein the profile further includes a second factor set associated primarily with the beneficiary.

25. The system of claim 24, wherein the second factor set includes age, size, medical conditions, skills, talents, and combinations thereof.

26. The system of claim 21, wherein the profile further includes a third factor set associated primarily with both the user and beneficiary.

27. The system of claim 26, wherein the third factor set includes geography, culture, social preferences, language preferences, adoption background, and combinations thereof.

28. The system of claim 1, wherein the profile includes factors selected from the group consisting of schedule, reason for matching, play dates for kids/pets, joint cultural activities, locating service providers such as nanny, pet-sitter, pediatrician, selling or exchanging information or items such as clothing, furniture, charity, photographs, health-related info, and combinations thereof.

29. The system of claim 1, wherein the profiles are stored on a secure, private database.

30. The system of claim 1, wherein the profile information is provided anonymously to a third party not associated with the matching of beneficiary with user consent.

31. The system of claim 30, wherein the information is used for market research and/or medical/social research.

32. The system of claim 30, wherein the information is used to provide services back to the users based on the profile.

33. The system of claim 32, wherein the services include participation in studies such as medical or product studies.

34. The system of claim 29, wherein the system is operable to permit the user to input, modify, delete, and/or store data input by that user.

35. A method for matching profiles in a system, comprising the steps of:
providing a system for reverse matching between parties, the system comprising:
at least one server hosting a secure database and connected to a network over which at least one remote, authorized user can access the server through the network using at least one remote computer or network access device operable to communicate and interface with the server, the server further including software for matching a profile entered by the user on behalf of at least one beneficiary, wherein the profile predominantly relates directly to the at least one beneficiary, not the user;
the user logging into the system via a user interface on the Internet;
the user paying a fee for a membership to participate in the matching by the system;
the user initializing the profile;
the system comparing the profile to others in its database; and
the system providing matching profiles to the user.

36. The method of claim 35, wherein the step of the user initializing the profile is operable based upon the user answering questions, making a free-form entry of information, uploading data such as pictures and links, and combinations thereof.

37. The method of claim 35, further including the step of the system suggesting categories for considering matches based on a completed profile.

38. The method of claim 35, further including the step of the user prioritizing factors within the profile.

39. The method of claim 35, further including the step of the system identifying a best match based upon entered profile and prioritized factors within the profile.

40. The method of claim 35, further including the step of the system notifying all users associated with matching profiles.

41. The method of claim 35, further including the step of each of the users notified by the system deciding and indicating a response to the system before the system completes the matching.

42. The method of claim 35, further including the step of the system providing contact info to users who have indicated acceptance of the matching.

43. The method of claim 42, further including the step of the users providing feedback to indicate satisfaction with the match.

44. The method of claim 43, wherein the system automatically learns what match types were unsatisfactory and avoids repeating those profile matches in later matches.

45. The method of claim 42, wherein the system advises the user on alternative profiles and/or prioritization of factors to improve matching results.
